(19) United States
(12) Patent Application Publication
(10) Pub. No.: US 2023/0002261 A1
(43) Pub. Date: Jan. 5, 2023

(54) MULTI-STAGE APPARATUS AND PROCESS FOR ADVANCED OXIDATION TREATMENT OF WASTEWATER

(71) Applicant: Nanjing University & Yancheng Academy of Environmental Protection Technology And Engineering, Yancheng (CN)

(72) Inventors: Lifang CHEN, Yancheng (CN); Xin QIU, Yancheng (CN); Lian WANG, Yancheng (CN); Jinnan WANG, Yancheng (CN); Jianjun DAI, Yancheng (CN); Aimin LI, Yancheng (CN)

(21) Appl. No.: 17/642,909

(22) PCT Filed: Jan. 8, 2021
(86) PCT No.: PCT/CN2021/070843

§ 371 Date: Mar. 14, 2022

(30) Foreign Application Priority Data
Feb. 13, 2020 (CN) 202010090992.7

(51) Int. Cl. C02F 1/72; C02F 1/32; C02F 1/78

(52) U.S. Cl. CPC C02F 1/725; C02F 1/325; C02F 1/722; C02F 1/78; C02F 2305/10; C02F 2101/306

(57) ABSTRACT

The present disclosure discloses a multi-stage apparatus and process for advanced oxidation treatment of wastewater, and belongs to the field of wastewater treatment in environmental protection. The apparatus includes a liquid-liquid mixing unit, a preheating unit, a gas-liquid mixing unit, a parallel photocatalytic reactor group and an oxidation tower connected in sequence. According to characteristics of free radical reactions, the parallel photocatalytic reactor group and the oxidation tower in the apparatus are reasonably designed, utilization rates of the ozone and the hydrogen peroxide are increased, and the wastewater treatment cost is reduced.

### TECHNICAL FIELD

The present disclosure belongs to the field of wastewater treatment in environmental protection, and specifically relates to a multi-stage apparatus and process for advanced oxidation treatment of wastewater.

### BACKGROUND

According to compositions of wastewater and a COD concentration, COD treatment of chemical wastewater can be conducted by using many different methods, such as wet oxidation, ozone oxidation, hydrogen peroxide oxidation, Fenton oxidation and aeration. Due to a good treatment effect, a low equipment investment cost, simple operation, high safety of a treatment process and other reasons, the ozone oxidation and the hydrogen peroxide oxidation have been widely popularized and applied in treatment of the wastewater with a low COD concentration.

However, both the ozone oxidation and the hydrogen peroxide oxidation have some problems. For example,

1. an unsatisfactory effect is achieved when a single treatment technology is used for treatment, and a better treatment effect is achieved when two technologies are combined for use; and

2. since the utilization efficiency of ozone and hydrogen peroxide in current treatment processes is not high, the operating cost is high, and generated exhaust needs to be further processed and then discharged to satisfy standards.

In further researches, an ultraviolet radiation method is combined with advanced oxidation of the ozone and the hydrogen peroxide. For example, a Chinese Patent Application with a publication number of CN110117115A in the prior art discloses a treatment equipment for recycling of industrial waste salts. The equipment includes a pretreatment unit, a resin adsorption unit, an advanced oxidation unit, an advanced treatment and anodic oxidation unit and an ionic membrane caustic soda production process unit connected in sequence. The pretreatment unit includes a waste salt dissolving device, a pH adjustment device and a mechanical impurity removal device connected in sequence; and the advanced oxidation unit includes an integrated device for combining ozone, ultraviolet radiation and hydrogen peroxide to conduct advanced oxidation, and a step of combining the ozone, the ultraviolet radiation and the hydrogen peroxide to conduct advanced oxidation to degrade organic matter in high-salt wastewater is used. However, in the prior art, when the integrated device for combining ozone, ultraviolet radiation and hydrogen peroxide to conduct advanced oxidation is used for reactions under same conditions, the following problems may be caused:

(1) the residence time of the ozone in a reactor is short, the utilization rate of the ozone is low (the utilization rate of the ozone is generally not higher than 60% under industrial treatment conditions), the concentration of the ozone in effluent is high, and the ozone in the effluent needs to be decomposed by using additional energy to ensure that the wastewater is discharged to satisfy the standards, so that the wastewater treatment cost is greatly increased;

(2) the hydrogen peroxide, the wastewater and the ozone are mixed unevenly, the ability of the hydrogen peroxide to generate free radicals with the ozone is reduced, and the utilization efficiency of the hydrogen peroxide is reduced; and

(3) the efficiency in a photocatalytic reaction stage of the wastewater in an integrated reactor is difficult to improve.

### SUMMARY

### 1. Problems to be Solved

In view of the problem that the utilization rate of ozone in a photocatalytic reaction stage of wastewater in an existing integrated reactor for photocatalytic ozone and hydrogen peroxide oxidation is difficult to improve, the present disclosure provides a multi-stage apparatus and process for advanced oxidation treatment of wastewater, and combined with characteristics of free radical reactions, parallel photocatalytic reactors and an oxidation tower are reasonably designed, so that a photocatalytic time of a system is in an ideal range when the ozone quickly generates free radicals, utilization rates of the ozone and hydrogen peroxide are increased, and the wastewater treatment cost is reduced;

furthermore, through step-by-step mixing, that is, evenly mixing the wastewater and the hydrogen peroxide first, raising the temperature to a target temperature and then conducting mixing with the ozone, the system temperature is in the range when the ozone quickly generates the free radicals, and the utilization rate of the ozone is further increased; and

furthermore, by arranging separate mixing units for liquid-liquid mixing or gas-liquid mixing, the problem of uneven mixing of the hydrogen peroxide, the wastewater and the ozone is solved.

### 2. Technical Solutions

In order to resolve the above problems, the present disclosure adopts the technical solutions as follows:

A multi-stage apparatus for advanced oxidation treatment of wastewater includes a liquid-liquid mixing unit, a preheating unit, a gas-liquid mixing unit, a parallel photocatalytic reactor group and an oxidation tower connected in sequence;

the liquid-liquid mixing unit is used for mixing to-be-treated wastewater and hydrogen peroxide;

the preheating unit is used for preheating a mixed solution of the to-be-treated wastewater and the hydrogen peroxide;

the gas-liquid mixing unit is used for mixing ozone at room temperature and the preheated mixed solution of the to-be-treated wastewater and the hydrogen peroxide to form a gas-liquid mixture; and

the parallel photocatalytic reactor group is internally provided with several photocatalytic reactors, and an ultraviolet lamp is arranged in the photocatalytic reactor.

Preferably, an effective volume of the oxidation tower is much greater than the sum of effective volumes of the photocatalytic reactors in the parallel photocatalytic reactor group, and the effective volume of the oxidation tower is generally 5-50 times the sum of the effective volumes of the photocatalytic reactors in the parallel photocatalytic reactor group. Herein, the effective volume refers to an actual volume of water contained in the oxidation tower or the photocatalytic reactor. According to a free radical reaction principle in a photocatalytic oxidation process, a rapid reaction is conducted in an initial reaction stage, that is, an intrinsic reaction rate is very high, high mass transfer efficiency is required to match the reaction, and just as a rapid working machine requires rapid feeding to achieve high efficiency. Therefore, high enough mass transfer efficiency is required in the initial reaction stage. Several parallel photocatalytic reactors are used to replace a traditional single-channel reactor so that gas-liquid mixing and mass transfer efficiency in each reactor can be maximized. On the one hand, it can be ensured that the reaction efficiency of the reactor is not reduced under a large processing capacity; and on the other hand, the processing capacity can be flexibly adjusted by only adjusting a use number of the photocatalytic reactors without affecting the reaction efficiency. In addition, the parallel photocatalytic reactors can be used for solving the problem of reduced photocatalytic efficiency caused by pollution of outer walls of the ultraviolet lamps in time. When the outer wall of one ultraviolet lamp is polluted, the reactor could be switched out of the system, the outer wall of the ultraviolet lamp could be cleaned, and the operation of the entire device is basically not affected.

Due to a large volume of the oxidation tower, a residence time of effluent out of the parallel photocatalytic reactor group is prolonged, a slow reaction is conducted in a later photocatalytic oxidation reaction stage, and at this time, high mass transfer efficiency is not required, but an enough residence time needs to be required. By using the large-volume oxidation tower, the reaction time can be prolonged, and at the same time, the operating energy consumption for a processing capacity per unit and the equipment investment can be minimized.

Preferably, a height-to-diameter ratio of the photocatalytic reactor is 8-15.

Preferably, a height-to-diameter ratio of the oxidation tower is 5-20.

Preferably, the ultraviolet lamp is axially arranged in a water flow direction.

Preferably, the ultraviolet lamp is installed in a glass tube, during operation, the glass tube is polluted by pollutants in wastewater, the photocatalytic efficiency is reduced, and the glass tube needs to be removed and cleaned regularly. The parallel photocatalytic reactor group is used for a rapid oxidation reaction. When inlet and outlet valves of the photocatalytic reactor are closed and residual liquid is completely discharged, the ultraviolet lamp tube can be removed and cleaned online.

Preferably, a guide plate is arranged on a cylinder wall of the photocatalytic reactor to accelerate turbulence of gas and liquid in the photocatalytic reactor and increase the backmixing degree of materials in the reactor. On the one hand, the gas and the liquid are mixed more evenly, and on the other hand, a surface renewal rate of the gas and the liquid is increased, so that a reaction rate in the photocatalytic reactor is increased.

Preferably, the oxidation tower is a plate tower, several layers of sieve trays are arranged in the tower for redistribution of a gas phase and a liquid phase, and specific structural sizes of the sieve trays are designed according to gas and liquid flow loads.

Preferably, a liquid-liquid static mixer is used as a liquid-liquid mixing equipment; and a gas-liquid static mixer is used as a gas-liquid mixing equipment.

Preferably, a fixed-tube-sheet heat exchanger is used as a preheater.

The present disclosure also provides a process for advanced oxidation treatment of wastewater by using the above apparatus, and the process includes the following steps:

S1: mixing to-be-treated wastewater and hydrogen peroxide;

S2: preheating a mixed solution of the to-be-treated wastewater and the hydrogen peroxide;

S3: mixing ozone at room temperature and the preheated mixed solution of the to-be-treated wastewater and the hydrogen peroxide to form a gas-liquid mixture;

S4: making the gas-liquid mixture enter the parallel photocatalytic reactor group for a reaction for a residence time t₁, where the residence time refers to a reaction time of a stage when a COD degradation rate k is equal to or greater than 1, and k refers to a decrease of a mass concentration of COD in the wastewater per minute with a unit of mg/(L·min); and

S5: making effluent in step S4 enter the oxidation tower for a residence time t₂ and then discharging the effluent, where the residence time refers to a reaction time of a stage when the COD degradation rate k is less than 1.

Preferably, the utilization efficiency of the ozone is higher than 80%, more preferably higher than 86%.

Preferably, a preheating temperature in step S2 is 50-65° C.

Preferably, the residence time t₁ in the parallel photocatalytic reactor group (rapid reaction) in step S4 is 1-60 min, and the residence time t₂ in the oxidation tower (slow reaction) in step S5 is 20-360 min. In this process, in the initial reaction stage, since the wastewater in the parallel photocatalytic reactor group can achieve rapid mass transfer, an ultraviolet light irradiation area of the wastewater per unit volume is large, the ozone and the hydrogen peroxide can be quickly stimulated to generate a large number of free radicals, and a free radical chain reaction stage is started; at this time, due to a guiding effect of the guide plate, turbulent mixing of gas and liquid in the parallel photocatalytic reactor is intensified, and a phase contact area of the gas and the liquid and the surface renewal rate are greatly increased, so that undegraded organic matter in the liquid phase is quickly mass transferred to a gas-liquid contact surface, and the reaction rate is increased; and due to the longer residence time in the oxidation tower, a free radical termination stage can have an enough residence time, so that a reaction is conducted more thoroughly, and finally the oxidation efficiency is improved.

### 3. Beneficial Effects

Compared with the prior art, the present disclosure has the following beneficial effects:

(1) In the multi-stage apparatus for advanced oxidation treatment of wastewater provided in the present disclosure, the parallel photocatalytic reactor group and the oxidation tower are arranged and connected in series for an advanced oxidation reaction; in the initial reaction stage, since the wastewater in the parallel photocatalytic reactor group can achieve rapid mass transfer, the ultraviolet light irradiation area of the wastewater per unit volume is large, the ozone and the hydrogen peroxide can be quickly stimulated to generate a large number of free radicals, and the free radical chain reaction stage is started, so that the reaction rate is increased; and due to the arranged oxidation tower, the free radical termination stage can have an enough residence time, so that a reaction is conducted more thoroughly, and finally the oxidation efficiency is improved;

(2) in the present disclosure, the effective volume of the oxidation tower is much greater than the sum of the effective volumes of the photocatalytic reactors in the parallel photocatalytic reactor group, this design is based on the free radical reaction principle in the photocatalytic oxidation process, a rapid reaction is conducted in the initial reaction stage, that is, the intrinsic reaction rate is very high, high mass transfer efficiency is required to match the reaction, therefore, high mass transfer efficiency is required in the initial reaction stage, and the several parallel photocatalytic reactors are used to replace a traditional single-channel reactor; and a slow reaction is conducted in the later photocatalytic oxidation reaction stage, at this time, high mass transfer efficiency is not required, but an enough residence time needs to be required, and therefore, the large-volume oxidation tower is used to provide an enough reaction time;

(3) in the present disclosure, the guide plate arranged in the parallel photocatalytic reactor has a guiding effect, so that turbulent mixing of the gas and the liquid in the reactor is intensified, the phase contact area of the gas and the liquid and the surface renewal rate are greatly increased, the undegraded organic matter in the liquid phase is quickly mass transferred to the gas-liquid contact surface, and the reaction rate is further increased;

(4) according to the process for advanced oxidation treatment of wastewater provided in the present disclosure, in step S4, the gas-liquid mixture enters the parallel photocatalytic reactor group for a reaction for a residence time t₁, where the residence time refers to a reaction time of a stage when the COD degradation rate k is equal to or greater than 1; a rapid free radical reaction is conducted in the parallel photocatalytic reactors with higher efficiency; in step S5, effluent in step S4 enters the oxidation tower for a residence time t₂, and then is discharged, where the residence time refers to a reaction time of a stage when the COD degradation rate k is less than 1; and the slow reaction stage is conducted in the large-volume oxidation tower, characteristics of the free radical reactions are better used, and not only can the processing cost be reduced, but also the processing efficiency is ensured; and

(5) in the present disclosure, the wastewater and the hydrogen peroxide are mixed and preheated in the preheating unit, and then a heated liquid-liquid mixture is mixed with the ozone at room temperature, so that the decomposition amount of the ozone is effectively reduced, and the utilization rate of the ozone can be maximized; and since the decomposition rate of the ozone is high, two problems need to be solved to increase the utilization rate of the ozone: first, it is ensured that the ozone and the wastewater are at optimal temperature conditions, the decomposition rate of the ozone is too high when the temperature is too high, the rate of generating free radicals by the ozone is very low when the temperature is too low, and it is found by the inventor through a lot of experiments that an optimal temperature range is 50-65° C.; and second, it needs to be ensured that the free radicals can quickly participate in a reaction when generated, based on a synergistic oxidation effect of the ozone and the hydrogen peroxide in the presence of the hydrogen peroxide, and the free radicals can quickly participate in a reaction under the synergistic effect of the hydrogen peroxide when generated by the ozone, so that the utilization rate of the ozone is increased (increased to 80% or above), and a basis is provided for subsequent generation of the free radicals in the parallel photocatalytic reactor group.

### BRIEF DESCRIPTION OF THE DRAWINGS

FIG. 1 is a flowchart showing a process and apparatus for advanced oxidation treatment of wastewater in the present disclosure;

FIG. 2 is a schematic diagram of a photocatalytic reactor in the present disclosure;

FIG. 3 shows change curves of a COD concentration and a k value with time in a small pilot test in Example 1;

FIG. 4 shows change curves of a COD concentration and a k value with time in a small pilot test in Example 2; and

FIG. 5 shows change curves of a COD concentration and a k value with time in a small pilot test in Example 3;

where, labels in the drawings are as follows: 1. wastewater tube; 2. hydrogen peroxide tube; 3. ozone tube; 4. oxidation effluent tube; 5. exhaust tube; 6. hydrogen peroxide feeding pump; 7. wastewater feeding pump; 8. liquid-liquid mixer; 9. preheater; 10. gas-liquid mixer; 11. photocatalytic reactor; 11-1. feeding port; 11-2. discharging port; 11-3. reactor cylinder; 11-4. ultraviolet lamp; 11-5, guide plate; 11-6, electrical wiring; and 12. oxidation tower.

### DETAILED DESCRIPTION

It should be noted that when one component is expressed as “being connected to” another component, the component may be directly connected to the another component, or two components may be directly integrated. At the same time, terms such as “upper”, “lower”, “left”, “right”, “middle” and other terms cited in this specification are only used for ease of description and are not intended to limit the implementable scope. Modifications or adjustments of a relative relationship shall be fall within the implementable scope of the present disclosure without substantively changing the technical content.

Unless otherwise defined, all technical and scientific terms used herein have the same meaning as commonly understood by a person skilled in the art of the present disclosure.

The present disclosure is further described below in conjunction with specific embodiments.

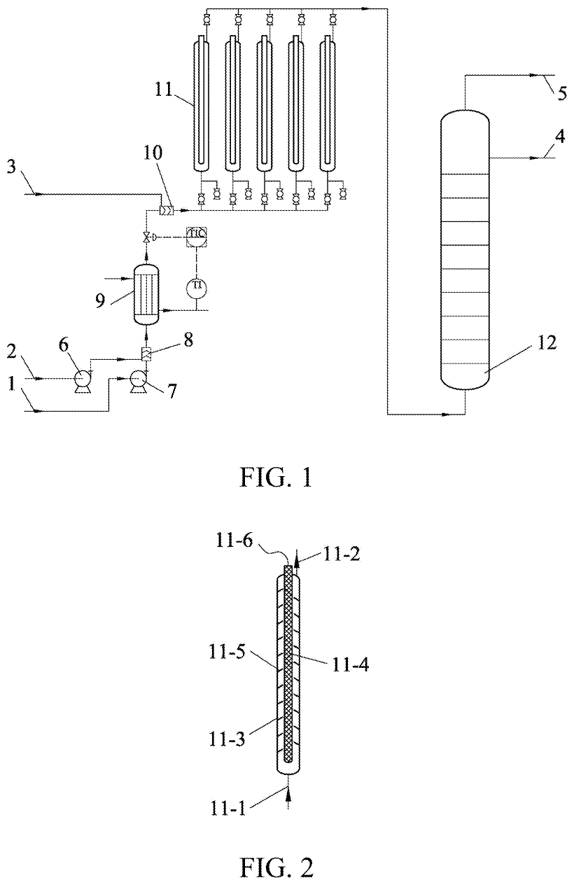

A photocatalytic ozone and hydrogen peroxide oxidation process of wastewater is a free radical reaction process and generally includes free radical initiation, a free radical chain reaction and free radical termination. In this process, main factors affecting an oxidation effect of the wastewater include generation of free radicals, a high enough mass transfer rate in a free radical chain reaction stage and an enough residence time in a free radical termination stage to ensure that a reaction is conducted more thoroughly. A wastewater treatment equipment and a process apparatus of the present disclosure are designed based on the photocatalytic ozone and hydrogen peroxide oxidation process of the wastewater. An operating process of the wastewater treatment process and apparatus of the present disclosure is described below with reference to FIG. 1.

As shown in FIG. 1, a multi-stage apparatus for advanced oxidation treatment of wastewater in the present disclosure includes a liquid-liquid mixing unit, a preheating unit, a gas-liquid mixing unit, a parallel photocatalytic reactor group and an oxidation tower connected in sequence; the liquid-liquid mixing unit is used for mixing to-be-treated wastewater and hydrogen peroxide; the preheating unit is used for preheating a mixed solution of the to-be-treated wastewater and the hydrogen peroxide; the gas-liquid mixing unit is used for mixing ozone at room temperature and the preheated mixed solution of the to-be-treated wastewater and the hydrogen peroxide to form a gas-liquid mixture; and the parallel photocatalytic reactor group is internally provided with several photocatalytic reactors, and an ultraviolet lamp is axially arranged in the photocatalytic reactor in a water flow direction. The ultraviolet lamp is installed in a glass tube, during operation, the glass tube is polluted by pollutants in the wastewater, the photocatalytic efficiency is reduced, and the glass tube needs to be removed and cleaned regularly; the parallel photocatalytic reactor group is used for a rapid oxidation reaction to shorten a residence time of materials in a photocatalytic reaction stage; and the oxidation tower is used for prolonging a residence time of effluent in the parallel photocatalytic reactor group.

A process flow specifically includes that the wastewater passing through a wastewater tube 1 and the hydrogen peroxide passing through a hydrogen peroxide tube 2 are pumped into a liquid-liquid mixer 8 for mixing by using a wastewater feeding pump 7 and a hydrogen peroxide feeding pump 6 respectively, preheated in a preheater 9 and mixed with the ozone from an ozone tube 3 in a gas-liquid mixer 10 to complete gas-liquid mixing and then enter each photocatalytic reactor 11 in the parallel photocatalytic reactor group. As shown in FIG. 2, an ultraviolet lamp 11-4 is axially arranged in the photocatalytic reactor 11 vertically, a guide plate 11-5 is arranged in a reactor cylinder 11-3, a water flow enters the photocatalytic reactor 11 through a feeding port 11-1 for a rapid oxidation reaction, the residence time of the materials in the photocatalytic reactor 11 is short, but due to an effect of the guide plate 11-5 in the photocatalytic reactor 11, a backmixing degree of the materials in the reactor is increased, and a reaction rate in the photocatalytic reactor 11 is greatly increased. Effluent is discharged from a discharging port 11-2 and then enters an oxidation tower 12 from a lower end, the oxidation tower 12 is a plate tower and is internally provided with several layers of sieve trays, finally effluent is discharged from an oxidation effluent tube 4, and gas is discharged from an exhaust tube 5.

The mixed solution of the wastewater and the hydrogen peroxide mixed by the liquid-liquid mixer 8 enters the preheater 9 and is preheated to 50-65° C. to facilitate generation of free radicals with maximum efficiency when mixed with the ozone in the next step; and a fixed-tube-sheet heat exchanger is generally used as the preheater 9, and a heat exchange area is calculated according to actual operating conditions and is generally 1-100 m². A discharge temperature of the mixed solution of the wastewater and the hydrogen peroxide from the preheater 9 is adjusted according to a flow rate of hot water (heat transfer oil or other heating media can also be used) of the heat exchanger.

The number and specification of the photocatalytic reactor 11 are determined according to an actual processing capacity, generally 5-60 photocatalytic reactors are appropriate, the inner diameter is generally 50-300 mm, and the height of the reactor is generally 500-2000 mm. The ultraviolet lamp 11-4 is installed in a glass tube, during actual operation, the glass tube of the ultraviolet lamp 11-4 is polluted by pollutants in the wastewater, the photocatalytic efficiency is reduced, and the glass tube needs to be removed and cleaned regularly.

Reaction effluent from a top of the photocatalytic reactor 11 is collected into a bottom of the oxidation tower 12 and flows through the oxidation tower from bottom to top for a further reaction. The residence time in the oxidation tower is generally 20-360 min, and after a reaction is completed, gas and liquid are discharged from a top of the tower and a side port in an upper part of the tower respectively.

### Example 1

In this example, wastewater (mainly containing pollutants such as glyphosate and formaldehyde with an influent COD concentration of 221 mg/L) was treated.

I. Investigation of the Change of a COD Degradation Rate During Wastewater Treatment by Using a Small Pilot Test

First, the change of the COD degradation rate during a wastewater reaction was investigated by using a small pilot test; and an apparatus and method used in the small pilot test were as follows:

in the small pilot test, a multi-stage apparatus for advanced oxidation treatment of wastewater shown in FIG. 1 was not used for treatment, but a single large-volume photocatalytic reactor was used, so that the whole reaction was conducted in the same photocatalytic reactor, where a volume of the photocatalytic reactor was 15 L, a photocatalytic power was 400 W, and an added amount of the wastewater was 10 L; and

a process for treatment of wastewater by using the above device included the following steps:

1) the to-be-treated wastewater and hydrogen peroxide were added into the photocatalytic reactor, where an added amount of the hydrogen peroxide was 20 mL (a mass concentration of the hydrogen peroxide was 30%);

2) a mixed solution of the to-be-treated wastewater and the hydrogen peroxide was preheated to 55° C.;

3) ozone at room temperature was introduced into the reactor, where an introduced amount of the ozone was 50 g/h; and

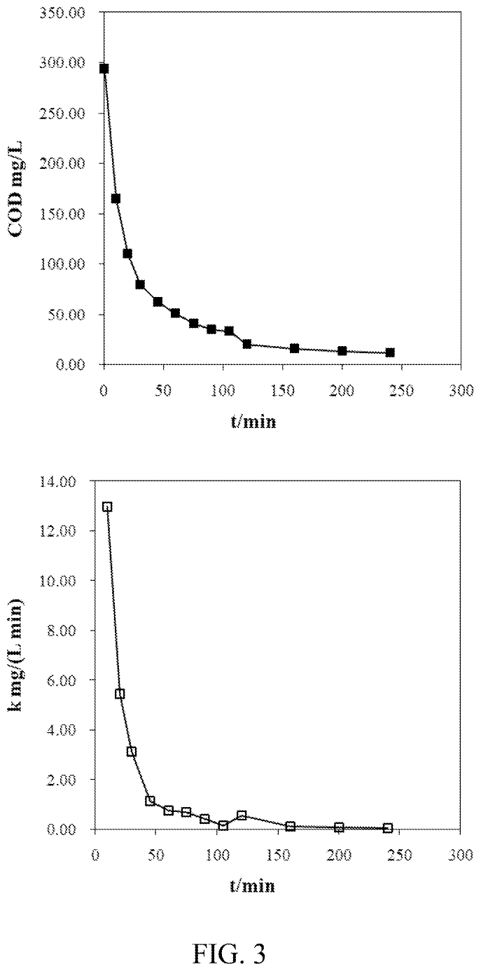

4) an effluent COD concentration was monitored and reached 11.7 mg/L within 240 min, where the change of the COD concentration with a reaction time t was shown in FIG. 3.

According to results of the small pilot test of the wastewater shown in FIG. 3 and results of an oxidation experiment of the wastewater, it was shown that it took 240 minutes to reach a target COD degradation value, the COD degradation rate was very high in the first 30 minutes, a decrease, namely a k value, of the COD concentration of the wastewater per minute was not less than 1, the COD degradation rate was significantly reduced in the next 210 minutes, the k value was reduced, and the reaction was mild.

II. Treatment of the Wastewater by Using the Equipment Shown in FIG. 1

Accordingly, the multi-stage apparatus for advanced oxidation treatment of wastewater shown in FIG. 1 (a specific structure was as described above) was used for normal treatment, that is, a parallel photocatalytic reactor group and an oxidation tower 12 were combined in series, and the wastewater was subjected to a rapid reaction in the parallel photocatalytic reactor group first and then stayed in the oxidation tower 12 for a period of time for a slow reaction, where, an inner diameter of a photocatalytic reactor 11 was 200 mm, a height of the photocatalytic reactor was 1600 mm, a volume of a single photocatalytic reactor 11 was about 50 L, a total of 50 photocatalytic reactors 11 were installed in parallel, and a total effective volume of the photocatalytic reactor group was about 2.5 m³; and a diameter of the oxidation tower 12 was 1600 mm, a height of the oxidation tower was 8.2 m, a total volume of the oxidation tower 12 was 17.5 m³, and a designed processing capacity was 5 m³/h.

Wastewater treatment included the following steps:

S1: the to-be-treated wastewater and hydrogen peroxide were mixed, where a flow rate of the wastewater was 5 m³/h, and an added amount of the hydrogen peroxide was 2 kg/h (a mass concentration of the hydrogen peroxide was 30%);

S2: a mixed solution of the to-be-treated wastewater and the hydrogen peroxide was preheated to 55° C.;

S3: ozone at room temperature was mixed with the preheated mixed solution of the to-be-treated wastewater and the hydrogen peroxide to form a gas-liquid mixture, where an introduced amount of the ozone was 1200 g/h;

S4: the gas-liquid mixture entered the parallel photocatalytic reactor group for a reaction at a photocatalytic power of 30 kw for a residence time t₁, where the residence time referred to a reaction time of a stage when the COD degradation rate k was equal to or greater than 1 in the small pilot test and was about 30 min; and

S5: effluent in step S4 entered the oxidation tower for a residence time t₂ and then was discharged, where the residence time referred to a reaction time of a stage when the COD degradation rate k was less than 1 in the small pilot test and was about 210 min. The COD concentration of the effluent from the oxidation tower was 9.35 mg/L and reached a target value.

The above results showed that when the parallel photocatalytic reactor group and the large-volume oxidation tower in this example were connected in series and the residence time was set accordingly, the ozone efficiency (a ratio of a theoretical required amount of the ozone to an actual added amount of the ozone, where a theoretical added amount of the ozone was equal to a decrease of the COD concentration, that is, a mass concentration of ΔCOD) was 88%; and it was worth noting that in existing industrial treatment, when a conventional process of photocatalytic ozone and hydrogen peroxide oxidation was used, the ozone efficiency was generally not higher than 60% (under the condition that an added ratio of the hydrogen peroxide and the photocatalytic power were basically the same). Therefore, by using the treatment process in this example, the utilization efficiency of the ozone can be greatly improved, and power consumption of an ozone generator was reduced.

### Example 2

In this example, wastewater (mainly containing pollutants such as ethers with an influent COD concentration of 86 mg/L) was treated.

I. Investigation of the Change of a COD Degradation Rate During Wastewater Treatment by Using a Small Pilot Test

First, the change of the COD degradation rate during a wastewater reaction was investigated by using a small pilot test; and an apparatus and method used in the small pilot test were as follows:

in the small pilot test, a multi-stage apparatus for advanced oxidation treatment of wastewater shown in FIG. 1 was not used for treatment, but a single large-volume photocatalytic reactor was used, so that the whole reaction was conducted in the same photocatalytic reactor, where a volume of the photocatalytic reactor was 15 L, a photocatalytic power was 400 W, and an added amount of the wastewater was 10 L; and

a process for treatment of wastewater by using the above device included the following steps:

1) the to-be-treated wastewater and hydrogen peroxide were added into the photocatalytic reactor, where an added amount of the hydrogen peroxide was 20 mL (a mass concentration of the hydrogen peroxide was 30%);

2) a mixed solution of the to-be-treated wastewater and the hydrogen peroxide was preheated to 50° C.;

3) ozone at room temperature was introduced into the reactor, where an introduced amount of the ozone was 20 g/h; and

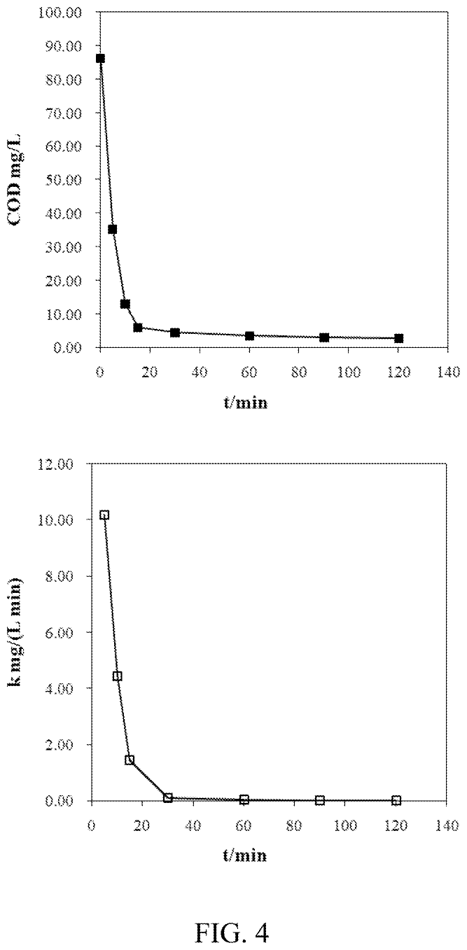

4) an effluent COD concentration was monitored and reached 2.8 mg/L within 120 min, where the change of the COD concentration with a reaction time t was shown in FIG. 4.

According to results of the small pilot test of the wastewater shown in FIG. 4 and results of an oxidation experiment of the wastewater, it was shown that it took 120 minutes to reach a target COD degradation value, the COD degradation rate was very high in the first 15 minutes, a k value was not less than 1, the COD degradation rate was significantly reduced in the next 105 minutes, and the reaction was mild.

II. Treatment of the Wastewater by Using the Equipment Shown in FIG. 1

Accordingly, the multi-stage apparatus for advanced oxidation treatment of wastewater shown in FIG. 1 (a specific structure was as described above) was used for normal treatment, that is, a parallel photocatalytic reactor group and an oxidation tower 12 were combined in series, and the wastewater was subjected to a rapid reaction in the parallel photocatalytic reactor group first and then stayed in the oxidation tower 12 for a period of time for a slow reaction, where, an inner diameter of a photocatalytic reactor 11 was 150 mm, a height of the photocatalytic reactor was 1400 mm, a volume of a single photocatalytic reactor 11 was about 25 L, a total of 30 photocatalytic reactors 11 were installed in parallel, and a total effective volume of the photocatalytic reactor group was about 0.75 m³; and a diameter of the oxidation tower 12 was 1000 mm, a height of the oxidation tower was 6.4 m, a total volume of the oxidation tower 12 was 5.25 m³, and a designed processing capacity was 3 m³/h.

Wastewater treatment included the following steps:

S1: the to-be-treated wastewater and hydrogen peroxide were mixed, where a flow rate of the wastewater was 3 m³/h, and an added amount of the hydrogen peroxide was 1 kg/h (a mass concentration of the hydrogen peroxide was 30%);

S2: a mixed solution of the to-be-treated wastewater and the hydrogen peroxide was preheated to 50° C.;

S3: ozone at room temperature was mixed with the preheated mixed solution of the to-be-treated wastewater and the hydrogen peroxide to form a gas-liquid mixture, where an introduced amount of the ozone was 300 g/h;

S4: the gas-liquid mixture entered the parallel photocatalytic reactor group for a reaction at a photocatalytic power of 22 kw for a residence time t₁, where the residence time referred to a reaction time of a stage when the COD degradation rate k was equal to or greater than 1 in the small pilot test and was about 15 min; and

S5: effluent in step S4 entered the oxidation tower for a residence time t₂ and then was discharged, where the residence time referred to a reaction time of a stage when the COD degradation rate k was less than 1 in the small pilot test and was about 105 min. The COD concentration of the effluent from the oxidation tower was 2.1 mg/L and reached a target value.

The above results showed that when the parallel photocatalytic reactor group and the large-volume oxidation tower in this example were connected in series and the residence time was set accordingly, the ozone efficiency (a ratio of a theoretical required amount of the ozone to an actual added amount of the ozone) was 86%; when a conventional process of photocatalytic ozone and hydrogen peroxide oxidation was used, the ozone efficiency was generally not higher than 60% (under the condition that an added ratio of the hydrogen peroxide and the photocatalytic power were basically the same); and similarly, by using the treatment process in this example, the utilization efficiency of the ozone can be greatly improved, and power consumption of an ozone generator was reduced.

### Example 3

In this example, wastewater (mainly containing pollutants such as phenoxycarboxylic acids with an influent COD concentration of 221 mg/L) was treated.

I. Investigation of the Change of a COD Degradation Rate During Wastewater Treatment by Using a Small Pilot Test

First, the change of the COD degradation rate during a wastewater reaction was investigated by using a small pilot test; and an apparatus and method used in the small pilot test were as follows:

in the small pilot test, a multi-stage apparatus for advanced oxidation treatment of wastewater shown in FIG. 1 was not used for treatment, but a single large-volume photocatalytic reactor was used, so that the whole reaction was conducted in the same photocatalytic reactor, where a volume of the photocatalytic reactor was 15 L, a photocatalytic power was 400 W, and an added amount of the wastewater was 10 L; and

a process for treatment of wastewater by using the above device included the following steps:

1) the to-be-treated wastewater and hydrogen peroxide were added into the photocatalytic reactor, where an added amount of the hydrogen peroxide was 20 mL (a mass concentration of the hydrogen peroxide was 30%);

2) a mixed solution of the to-be-treated wastewater and the hydrogen peroxide was preheated to 62° C.;

3) ozone at room temperature was introduced into the reactor, where an introduced amount of the ozone was 50 g/h; and

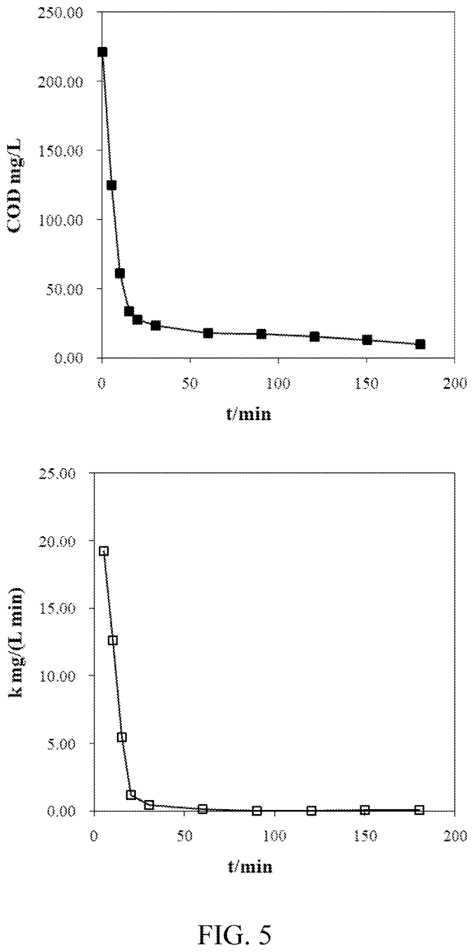

4) an effluent COD concentration was monitored and reached 10.35 mg/L within 180 min, where the change of the COD concentration with a reaction time t was shown in FIG. 5.

According to results of the small pilot test of the wastewater shown in FIG. 5 and results of an oxidation experiment of the wastewater, it was shown that it took 180 minutes to reach a target COD degradation value, the COD degradation rate was very high in the first 20 minutes, a k value was not less than 1, the COD degradation rate was significantly reduced in the next 160 minutes, and the reaction was mild.

II. Treatment of the Wastewater by Using the Equipment Shown in FIG. 1

Accordingly, the multi-stage apparatus for advanced oxidation treatment of wastewater shown in FIG. 1 (a specific structure was as described above) was used for normal treatment, that is, a parallel photocatalytic reactor group and an oxidation tower 12 were combined in series, and the wastewater was subjected to a rapid reaction in the parallel photocatalytic reactor group first and then stayed in the oxidation tower 12 for a period of time for a slow reaction, where, an inner diameter of a photocatalytic reactor 11 was 80 mm, a height of the photocatalytic reactor was 1100 mm, a volume of a single photocatalytic reactor 11 was about 5.6 L, a total of 60 photocatalytic reactors 11 were installed in parallel, and a total effective volume of the photocatalytic reactor group was about 0.33 m³; and a diameter of the oxidation tower 12 was 750 mm, a height of the oxidation tower was 5.8 m, a total volume of the oxidation tower 12 was 2.67 m³, and a designed processing capacity was 1 m³/h.

Wastewater treatment included the following steps:

S1: the to-be-treated wastewater and hydrogen peroxide were mixed, where a flow rate of the wastewater was 1 m³/h, and an added amount of the hydrogen peroxide was 0.5 kg/h (a mass concentration of the hydrogen peroxide was 30%);

S2: a mixed solution of the to-be-treated wastewater and the hydrogen peroxide was preheated to 62° C.;

S3: ozone at room temperature was mixed with the preheated mixed solution of the to-be-treated wastewater and the hydrogen peroxide to form a gas-liquid mixture, where an introduced amount of the ozone was 250 g/h;

S4: the gas-liquid mixture entered the parallel photocatalytic reactor group for a reaction at a photocatalytic power of 15 kw for a residence time t₁, where the residence time referred to a reaction time of a stage when the COD degradation rate k was equal to or greater than 1 in the small pilot test and was about 20 min; and

S5: effluent in step S4 entered the oxidation tower for a residence time t₂ and then was discharged, where the residence time referred to a reaction time of a stage when the COD degradation rate k was less than 1 in the small pilot test and was about 160 min. The COD concentration of the effluent from the oxidation tower was 10.2 mg/L and reached a target value.

The above results showed that when the parallel photocatalytic reactor group and the large-volume oxidation tower in this example were connected in series and the residence time was set accordingly, the ozone efficiency (a ratio of a theoretical required amount of the ozone to an actual added amount of the ozone) was 88.4%; as described above, in existing industrial treatment, when a conventional process of photocatalytic ozone and hydrogen peroxide oxidation was used, the ozone efficiency was generally not higher than 60% (under the condition that an added ratio of the hydrogen peroxide and the photocatalytic power were basically the same); and similarly, by using the treatment process in this example, the utilization efficiency of the ozone can be greatly improved, and power consumption of an ozone generator was reduced.

The above content is a schematic description of the present disclosure and embodiments thereof. The description is not restrictive. What is shown in the accompanying drawings is only one of the embodiments of the present disclosure, and the actual structure is not limited thereto. Therefore, similar structures and embodiments designed by a person of ordinary skill in the art as inspired by the disclosure herein without departing from the spirit of the present disclosure and without creative efforts shall fall within the protection scope of the present disclosure.

1. A multi-stage apparatus for advanced oxidation treatment of wastewater, comprising a liquid-liquid mixing unit, a preheating unit, a gas-liquid mixing unit, a parallel photocatalytic reactor group and an oxidation tower connected in sequence; wherein
the liquid-liquid mixing unit is used for mixing to-be-treated wastewater and hydrogen peroxide;
the preheating unit is used for preheating a mixed solution of the to-be-treated wastewater and the hydrogen peroxide;
the gas-liquid mixing unit is used for mixing ozone at room temperature and the preheated mixed solution of the to-be-treated wastewater and the hydrogen peroxide to form a gas-liquid mixture; and
the parallel photocatalytic reactor group is internally provided with several photocatalytic reactors.

2. The multi-stage apparatus for advanced oxidation treatment of wastewater according to claim 1, wherein an effective volume of the oxidation tower is greater than a sum of effective volumes of the photocatalytic reactors in the parallel photocatalytic reactor group.

3. The multi-stage apparatus for advanced oxidation treatment of wastewater according to claim 2, wherein the effective volume of the oxidation tower is 5-50 times the sum of the effective volumes of the photocatalytic reactors in the parallel photocatalytic reactor group.

4. The multi-stage apparatus for advanced oxidation treatment of wastewater according to claim 2, wherein a height-to-diameter ratio of the photocatalytic reactor is 8-15; and/or a height-to-diameter ratio of the oxidation tower is 5-20.

5. The multi-stage apparatus for advanced oxidation treatment of wastewater according to claim 2, wherein an ultraviolet lamp is axially arranged in the photocatalytic reactor in a water flow direction.

6. The multi-stage apparatus for advanced oxidation treatment of wastewater according to claim 2, wherein a guide plate is arranged on a cylinder wall of the photocatalytic reactor.

7. The multi-stage apparatus for advanced oxidation treatment of wastewater according to claim 2, wherein a liquid-liquid static mixer is used as a liquid-liquid mixing equipment; and a gas-liquid static mixer is used as a gas-liquid mixing device.

8. A process for advanced oxidation treatment of wastewater by using a multi-stage apparatus, the multi-stage apparatus comprising a liquid-liquid mixing unit, a preheating unit, a gas-liquid mixing unit, a parallel photocatalytic reactor group and an oxidation tower connected in sequence; wherein
the liquid-liquid mixing unit is used for mixing to-be-treated wastewater and hydrogen peroxide;
the preheating unit is used for preheating a mixed solution of the to-be-treated wastewater and the hydrogen peroxide;
the gas-liquid mixing unit is used for mixing ozone at room temperature and the preheated mixed solution of the to-be-treated wastewater and the hydrogen peroxide to form a gas-liquid mixture;
the parallel photocatalytic reactor group is internally provided with several photocatalytic reactors; and
the process comprising the following steps:
S1: mixing to-be-treated wastewater and hydrogen peroxide;
S2: preheating a mixed solution of the to-be-treated wastewater and the hydrogen peroxide;
S3: mixing ozone at room temperature and the preheated mixed solution of the to-be-treated wastewater and the hydrogen peroxide to form a gas-liquid mixture;
S4: making the gas-liquid mixture enter the parallel photocatalytic reactor group for a reaction for a residence time t₁, wherein the residence time refers to a reaction time of a stage when a COD degradation rate k is equal to or greater than 1; and
S5: making effluent in step S4 enter the oxidation tower for a residence time t₂ and then discharging the effluent, wherein the residence time refers to a reaction time of a stage when the COD degradation rate k is less than 1;
wherein k refers to a decrease of a mass concentration of COD in the wastewater per minute with a unit of mg/(L·min).

9. The process for advanced oxidation treatment of wastewater according to claim 8, wherein a preheating temperature in step S2 is 50-65° C.

10. The process for advanced oxidation treatment of wastewater according to claim 8, wherein the residence time t₁ in the parallel photocatalytic reactor group in step S4 is 1-60 min, and the residence time t₂ in the oxidation tower in step S5 is 20-360 min.

11. The process for advanced oxidation treatment of wastewater according to claim 9, wherein the residence time t₁ in the parallel photocatalytic reactor group in step S4 is 1-60 min, and the residence time t₂ in the oxidation tower in step S5 is 20-360 min.

12. A process for advanced oxidation treatment of wastewater by using a multi-stage apparatus, the multi-stage apparatus comprising a liquid-liquid mixing unit, a preheating unit, a gas-liquid mixing unit, a parallel photocatalytic reactor group and an oxidation tower connected in sequence; wherein
the liquid-liquid mixing unit is used for mixing to-be-treated wastewater and hydrogen peroxide;
the preheating unit is used for preheating a mixed solution of the to-be-treated wastewater and the hydrogen peroxide;
the gas-liquid mixing unit is used for mixing ozone at room temperature and the preheated mixed solution of the to-be-treated wastewater and the hydrogen peroxide to form a gas-liquid mixture;
the parallel photocatalytic reactor group is internally provided with several photocatalytic reactors;
the effective volume of the oxidation tower is 5-50 times the sum of the effective volumes of the photocatalytic reactors in the parallel photocatalytic reactor group; and
the process comprising the following steps:
S1: mixing to-be-treated wastewater and hydrogen peroxide;
S2: preheating a mixed solution of the to-be-treated wastewater and the hydrogen peroxide;
S3: mixing ozone at room temperature and the preheated mixed solution of the to-be-treated wastewater and the hydrogen peroxide to form a gas-liquid mixture;
S4: making the gas-liquid mixture enter the parallel photocatalytic reactor group for a reaction for a residence time t₁, wherein the residence time refers to a reaction time of a stage when a COD degradation rate k is equal to or greater than 1; and
S5: making effluent in step S4 enter the oxidation tower for a residence time t₂ and then discharging the effluent, wherein the residence time refers to a reaction time of a stage when the COD degradation rate k is less than 1;
wherein k refers to a decrease of a mass concentration of COD in the wastewater per minute with a unit of mg/(L·min).

13. The process for advanced oxidation treatment of wastewater according to claim 12, wherein a preheating temperature in step S2 is 50-65° C.

14. The process for advanced oxidation treatment of wastewater according to claim 12, wherein the residence time t₁ in the parallel photocatalytic reactor group in step S4 is 1-60 min, and the residence time t₂ in the oxidation tower in step S5 is 20-360 min.
